(19) United States
(12) Patent Application Publication
(10) Pub. No.: US 2026/0187352 A1
(43) Pub. Date: Jul. 2, 2026

(54) Generating a Contextual Travel Summary

(71) Applicant: Google LLC, Mountain View, CA (US)

(72) Inventors: Lily Duraiswami, Highlands Ranch, CO (US); Yi-Jo Liu, Campbell, CA (US); Daniel C. Seifert, Poughkeepsie, NY (US); Golden Gopal Krishna, Albany, CA (US); Shadia Walsh, San Francisco, CA (US); Carl Magnus Borg, San Francisco, CA (US); Tami Tchang-Mee Kim, Belmont, CA (US); Clifford Tse Yan Chan, San Francisco, CA (US)

(73) Assignee: Google LLC, Mountain View, CA (US)

(21) Appl. No.: 19/431,092

(22) Filed: Dec. 23, 2025

Related U.S. Application Data
(60) Provisional application No. 63/740,818, filed on Dec. 31, 2024.

(51) Int. Cl. G06F 40/166; G06F 40/134; G06F 40/40

(52) U.S. Cl. CPC G06F 40/166; G06F 40/134; G06F 40/40

(57) ABSTRACT

Techniques and apparatuses are described for generating a contextual travel summary. In example aspects, a device generates a contextual travel summary in a natural language format using artificial intelligence. The contextual travel summary includes easy-to-understand information about a travel situation involving a particular entity, which can represent the device itself, a second device, or a person carrying the device. In some implementations, the contextual travel summary can be used to provide a suggested reply in a communication application. Additionally or alternatively, the contextual travel summary can be automatically updated in real time and can be accessed by an authorized recipient or can be provided to the authorized recipient as a notification. Use of the contextual travel summary can make it convenient for people to provide or receive travel details that are readily understandable. It also provides richer information for an acquaintance to monitor the person's travel for safety reasons.

### CROSS-REFERENCE TO RELATED APPLICATION

This application claims the benefit of U.S. Provisional Patent Application Ser. No. 63/740,818, filed on Dec. 31, 2024, the disclosure of which is incorporated by reference herein in its entirety.

### BACKGROUND

Traveling is an everyday occurrence for people. Whether flying to a foreign country, sailing to an island, taking a subway or train to work, driving a car or motorcycle to school, riding a bus to a store, pedaling on a bike to a coffee shop, hiking in the hills, going horseback riding, or running outdoors, people are often moving to different locations and can utilize a variety of different transportation options to reach their desired destination.

Traveling is not always uneventful. Unexpected delays, vehicle breakdowns, inclement weather, and road construction can extend travel times or cause travel plans to change. In many situations, a person may wish to inform friends, family, or coworkers of their travel situation. In addition to providing a more up-to-date estimation of arrival, informing others of the travel situation can facilitate coordination for a meetup and/or provide a measure of safety. There is a general need to provide a convenient way for an individual to share their travel situation with others.

### SUMMARY

Techniques and apparatuses are described for generating a contextual travel summary. In example aspects, a device generates a contextual travel summary in a natural language format using artificial intelligence. The contextual travel summary includes easy-to-understand information about a travel situation involving a particular entity, which can represent the device itself, a second device, or a person carrying the device. More specifically, the contextual travel summary can include information about where the entity is currently located, when the entity is likely to reach its destination, the type of environment the entity is traversing, how the entity is traveling, and/or any events or situations that can impact the entity's travel situation. Example types of information compiled in a contextual travel summary can include information associated with the mode of transportation (e.g., walking, driving, or riding a train), impacts to travel (e.g., delays, traffic, detours, weather, or a natural disaster), the environment (e.g., nearby landmarks, cellular coverage, or street safety conditions), device and/or vehicle status (e.g., tire pressure or an available power level), and/or the presence (or absence) of a travel companion. In some implementations, the contextual travel summary can be used to provide a suggested reply in a communication application. Additionally or alternatively, the contextual travel summary can be automatically updated in real time and can be accessed by an authorized recipient or can be provided to the authorized recipient as a notification. Use of the contextual travel summary can make it convenient for people to provide or receive travel details that are readily understandable. It also provides richer information for an acquaintance to monitor the person's travel for safety reasons.

Aspects described below include a method performed by a first device for generating a contextual travel summary. The method includes receiving travel information about a second device that is being transported. The method also includes generating a contextual travel summary by summarizing the travel information in a natural language. The contextual travel summary describes a current travel situation associated with the second device. The method further includes presenting the contextual travel summary to a user of the first device.

Aspects described below also include an apparatus configured to perform any of the described methods.

Aspects described below include a computer-readable storage medium comprising instructions that, responsive to execution by a processor, cause an apparatus to perform any one of the described methods.

Aspects described below also include a system with means for generating a contextual travel summary.

### BRIEF DESCRIPTION OF DRAWINGS

Apparatuses and techniques for generating a contextual travel summary are described with reference to the following drawings. The same numbers are used throughout the drawings to reference like features and components:

FIG. 1-1 illustrates an example environment in which techniques for generating a contextual travel summary can be implemented;

FIG. 1-2 illustrates an example communication application providing a contextual travel summary;

FIG. 2-1 illustrates example environments in which techniques for generating a contextual travel summary can be implemented using a travel device and an interface device;

FIG. 2-2 illustrates an example notification application providing a contextual travel summary;

FIG. 3-1 illustrates other example environments in which techniques for generating a contextual travel summary can be implemented using a travel device and an interface device;

FIG. 3-2 illustrates an example people application providing a contextual travel summary corresponding to different people;

FIG. 4 illustrates example information that can be included as part of a contextual travel summary;

FIG. 5 illustrates an example implementation of a device that can implement aspects of generating a contextual travel summary;

FIG. 6 illustrates example types of travel information that can be used to generate a contextual travel summary;

FIG. 7 illustrates an example implementation of a contextual travel summary generator capable of generating a contextual travel summary;

FIG. 8 illustrates an example method for generating a contextual travel summary; and

FIG. 9 illustrates an example computing system embodying, or in which techniques may be implemented that enable use of, generation of a contextual travel summary.

### DETAILED DESCRIPTION

Traveling is not always uneventful. Unexpected delays, vehicle breakdowns, inclement weather, and road construction can extend travel times or cause travel plans to change. In many situations, a person may wish to inform friends, family, or coworkers of their travel situation. In addition to providing a more up-to-date estimation of arrival, informing others of the travel situation can facilitate coordination for a meetup and/or provide a measure of safety. There is a general need to provide a convenient way for an individual to share their travel situation with others.

Some devices allow a user to share their current location (e.g., their live location) to a specified recipient. The location information can identify a particular street address or geographic coordinates corresponding to a location of a device that is carried by the person. This type of information, however, is not necessarily easy for the recipient to understand. The recipient may not be familiar with the provided street address, for instance. If the recipient views the geographic coordinates on a digital map, they may need to scan the map for nearby locations that are recognizable to better comprehend the sender's location and/or to determine how far away the sender is from their destination. Furthermore, simple location information may fail to provide additional context about when and/or how the user may arrive at their destination.

To address these issues, techniques are described for generating a contextual travel summary. In example aspects, a device generates a contextual travel summary in a natural language format using artificial intelligence. The contextual travel summary includes easy-to-understand information about a travel situation involving a particular entity, which can represent the device itself, a second device, or a person carrying the device. More specifically, the contextual travel summary can include information about where the entity is currently located, when the entity is likely to reach its destination, the type of environment the entity is traversing, how the entity is traveling, and/or any events or situations that can impact the entity's travel situation. Example types of information compiled in a contextual travel summary can include information associated with the mode of transportation (e.g., walking, driving, or riding a train), impacts to travel (e.g., delays, traffic, detours, weather, or a natural disaster), the environment (e.g., nearby landmarks, cellular coverage, or street safety conditions), device and/or vehicle status (e.g., tire pressure or an available power level), and/or the presence (or absence) of a travel companion. In some implementations, the contextual travel summary can be used to provide a suggested reply in a communication application. Additionally or alternatively, the contextual travel summary can be automatically updated in real time and can be accessed by an authorized recipient or can be provided to the authorized recipient as a notification. Use of the contextual travel summary can make it convenient for people to provide or receive travel details that are readily understandable. It also provides richer information for an acquaintance to monitor the person's travel for safety reasons.

### Operating Environment

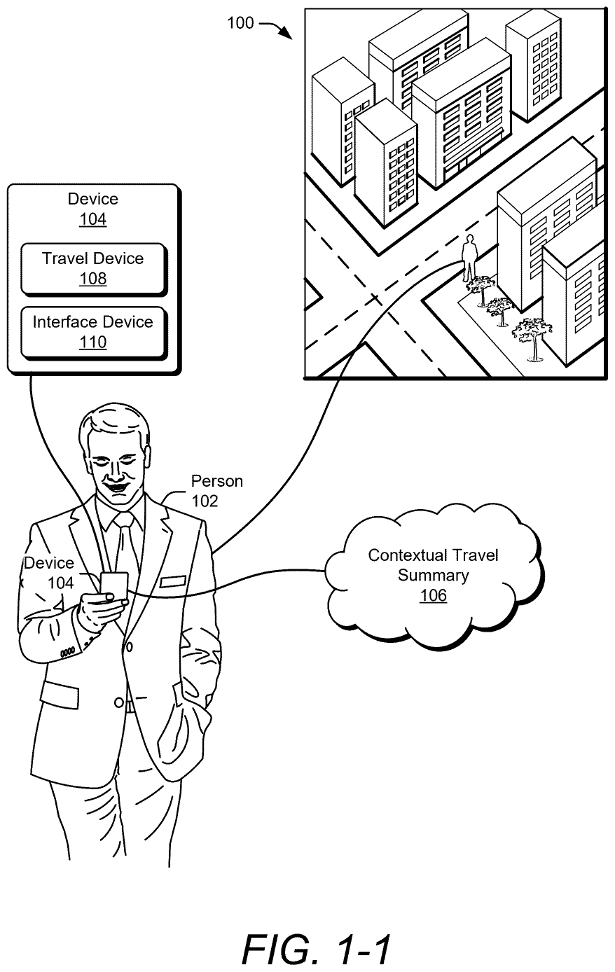

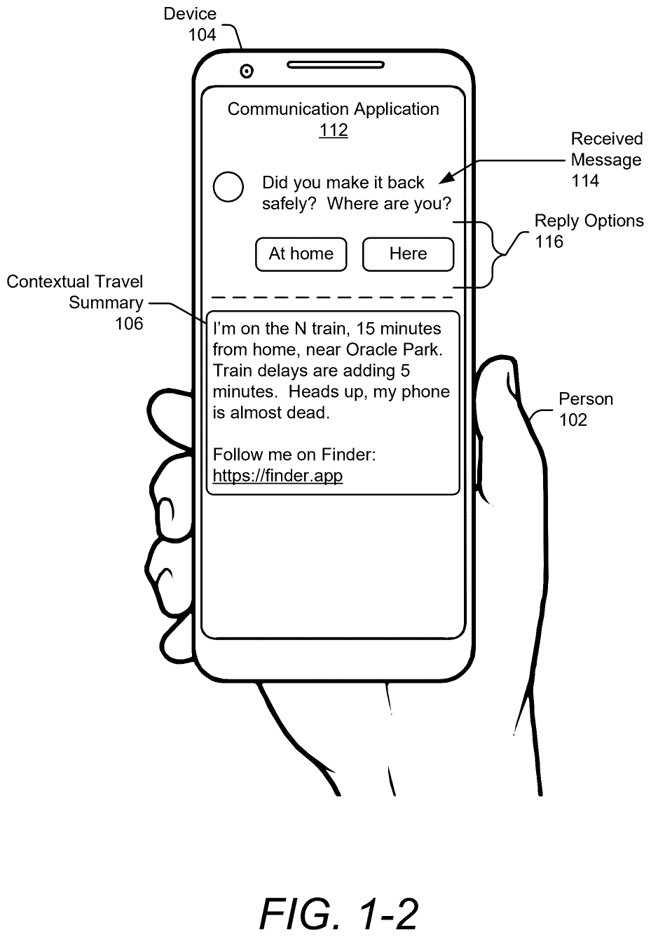

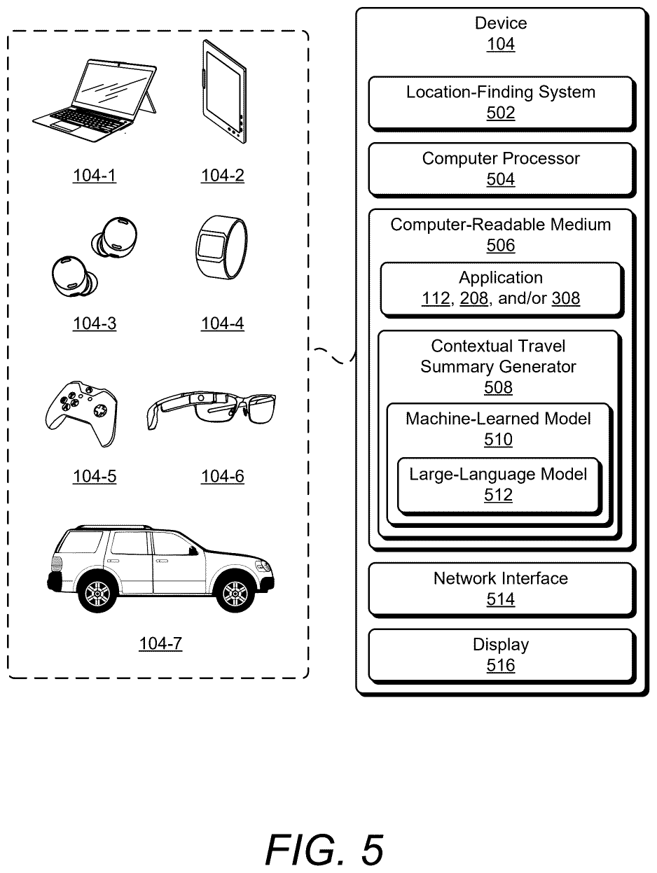

FIG. 1-1 is an illustration of an example environment 100 in which generating a contextual travel summary can be implemented. In the environment 100, a person 102 travels with a device 104. The person 102 may own the device 104 or may be an authorized user of the device 104. In this situation, the person 102 and the device 104 are co-located, which means that a location of the device 104 can also represent a location of the person 102. In an example implementation, the device 104 is a handheld device that provides navigation instructions to assist the person 102 in reaching their destination. Although depicted as a smartphone, the device 104 can include other types of devices, including those described with respect to FIG. 5.

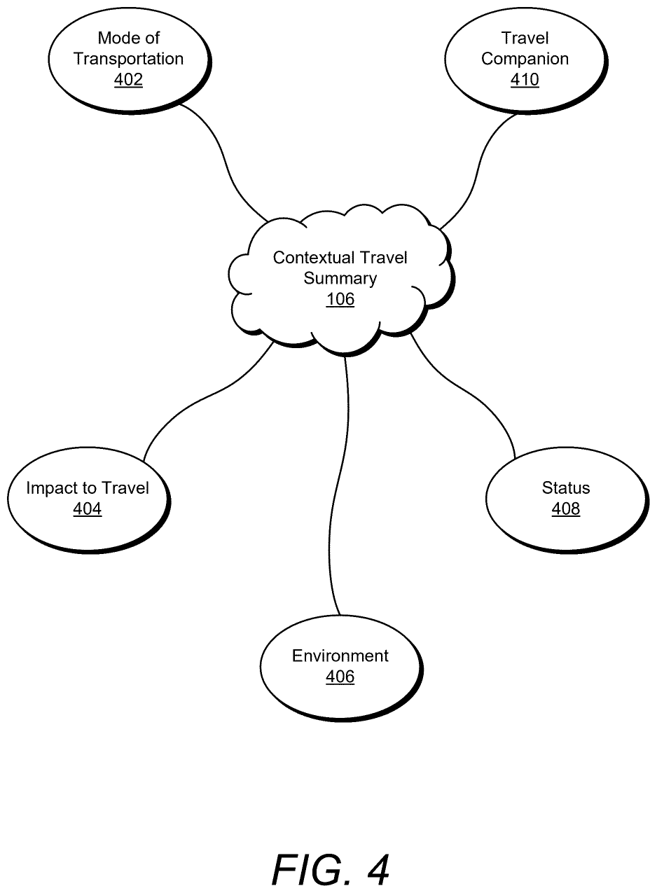

In many situations, the person 102 may wish to inform friends, family, or coworkers of their travel situation. In addition to providing a more up-to-date estimation of arrival, informing others of the travel situation can facilitate coordination for a meetup and/or provide a measure of safety. To assist with this, the device 104 generates a contextual travel summary 106 to provide an easy-to-understand summary of the person 102's travel situation. The contextual travel summary 106 can provide richer details in addition to where the person 102 is currently located and when the person 102 is estimated to arrive at their destination. For example, the contextual travel summary 106 can indicate how the person 102 is traveling, identify situations or events that can impact the person 102's travel, describe the current environment the person 102 is traversing, relay information regarding a status of the device 104 and/or a vehicle, and/or identify known travel companions, as further described with respect to FIG. 4.

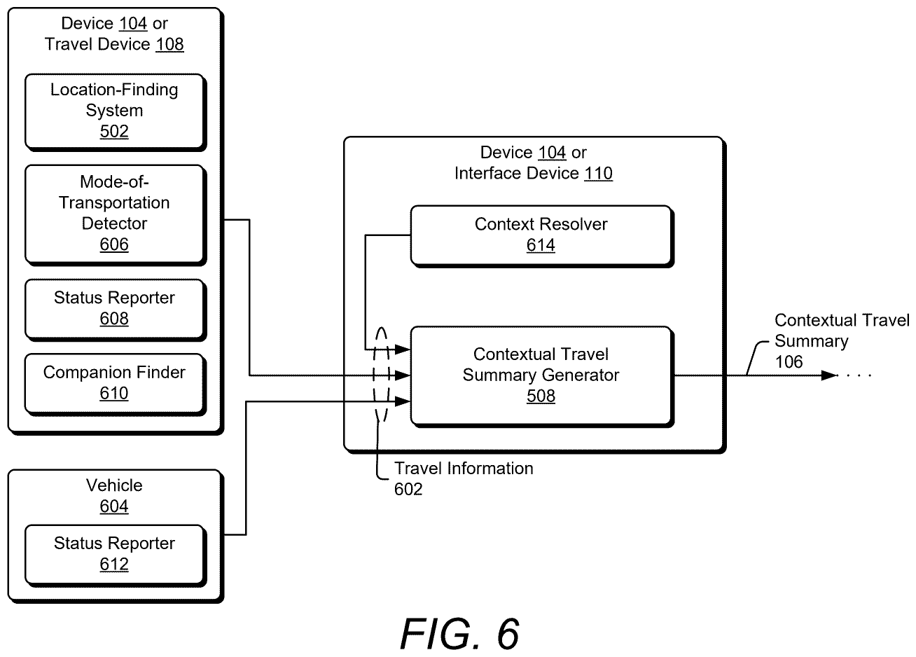

The contextual travel summary 106 is formatted in a natural language using artificial intelligence, as further described with respect to FIG. 6. The natural language refers to a human language, which can be presented in the form of text or images (e.g., status symbols). The generation of the contextual travel summary 106 can be further customized or tailored based on its intended use for a given situation. Consider an example in which the person 102 received a message from a contact asking if the person 102 is on their way home. In this case, the contextual travel summary 106 can indicate that the person 102 is running late because they had to go back to the office, provide information identifying nearby landmarks associated with the person's current location, and provide information regarding any delays. Consider another example in which the person 102 is trying to meet up with a friend at a crowded event (e.g., at a sports game or at a music concert). In this case, the contextual travel summary 106 can provide information that assists the friend in determining how the person 102 is traveling towards them, including the person's general location relative to the friend and a direction that they are walking.

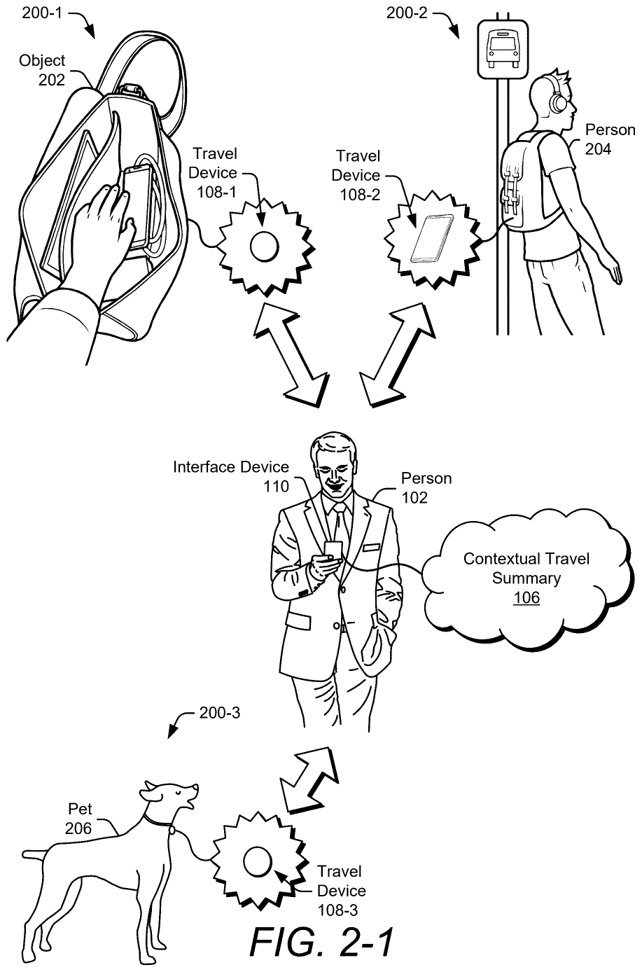

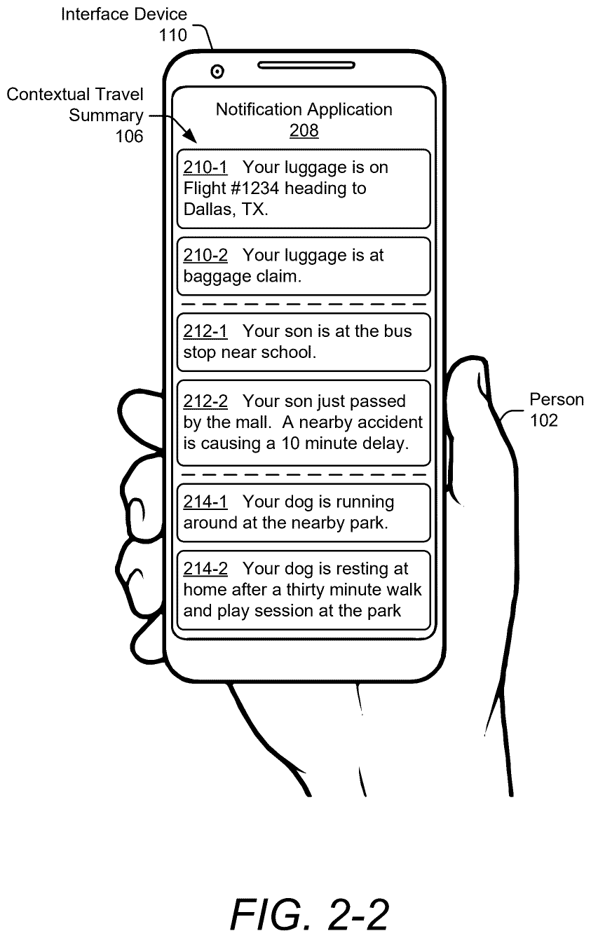

In the example environment 100, the device 104 functions both as a travel device 108 and an interface device 110. By operating as the travel device 108, the device 104 can determine its location and generate travel information that is provided as an input for generating the contextual travel summary 106. By operating as the interface device 110, the device 104 can generate the contextual travel summary 106 and present the contextual travel summary 106 to the person 102. The person 102 can use an application to share the contextual travel summary 106 with an authorized recipient, as further described with respect to FIG. 1-2.

FIG. 1-2 illustrates an example communication application 112 running on the device 104. Through the communication application 112, the person 102 receives a message 114 (received message 114). The message 114 asks the person 102 “Did you make it back safely? Where are you?” The communication application 112 provides several reply options 116 based on the received message 114. Example reply options 116 can include an option for the person 102 to reply with “At home” or “Here.” While each of the reply options 116 provide a quick means for responding to the sender of the message 114, if the person 102 is still traveling, the available responses can lack additional context and can fail to describe the person 102's current travel situation.

To address this, the device 104 generates the contextual travel summary 106, which represents a suggested response. An example contextual travel summary 106 reads “I'm on the N train, 15 minutes from home, near Oracle Park. Train delays are adding 5 minutes. Heads up, my phone is almost dead.” The contextual travel summary 106 can also include a secure link enabling the recipient to view a current location of the person 102 via a navigation application or relative to a digital map. The secure link can be designed to prevent an unauthorized person or an unauthorized device from accessing the information about the person 102's location.

As can be seen in this example, the contextual travel summary 106 is in a natural language and includes information such as the mode of transportation (e.g., train), an impact to travel (e.g., a train delay), a nearby landmark that is likely to be known by the recipient (e.g., near Oracle Park), and the device's status (e.g., a low-battery condition). The person 102 can further edit and/or approve the text of the contextual travel summary 106 prior to using it to respond to the sender of the message 114 (e.g., prior to the device 104 transmitting the contextual travel summary 106). The automatic generation of the contextual travel summary 106 can make it easier for the person 102 to respond to the received message 114, and the additional details of the contextual travel summary 106 can give the sender of the received message 114 further knowledge of the person 102's travel situation. In some situations, this additional information about the person 102's travel situation can provide the recipient peace of mind regarding the person 102's safety.

In the example described in FIGS. 1-1 and 1-2, the same device 104 travels with the person 102 and generates the contextual travel summary 106. Other implementations are also possible in which a first device is transported to a destination and a second device generates the contextual travel summary 106, as further described with respect to FIG. 2-1.

FIG. 2-1 is an illustration of example environments 200-1, 200-2, and 200-3 in which techniques for generating a contextual travel summary can be implemented using two separate devices: a travel device 108 and an interface device 110. In general, the travel device 108 can determine and/or report its location using some type of location service (e.g., using Bluetooth®, cellular, or a global-navigation satellite system (GNSS)). In example implementations, the travel device 108 can be a tracking device (e.g., a smart tag) or another smartphone. In some cases, the travel device 108 can provide additional travel information, such as information regarding the mode of transportation, information about its status, and/or status information of a vehicle that is used as the mode of transportation, as further described with respect to FIG. 6.

In example situations, an owner or an authorized user of a travel device 108 grants permission for the travel device 108 to communicate the travel information to the interface device 110. In some cases, the person 102 owns or has authorization to use both the travel device 108 and the interface device 110. In other cases, the travel device 108 and the interface device 110 are owned by different people. With the travel information provided by the travel device 108, the interface device 110 can generate the contextual travel summary 106 and present the contextual travel summary 106 to the person 102.

In a first example situation, the contextual travel summary 106 can help the person 102 keep track of an object 202 that is in transit with the travel device 108. Additionally or alternatively, the contextual travel summary 106 can be used to help the person 102 or law enforcement to recover an object 202 that was stolen. Consider the environment 200-1 in which the person 102 places and/or attaches a first travel device 108-1 inside of an object 202, such as their luggage. The interface device 110 can generate a contextual travel summary 106 based on the travel information provided by the first travel device 108-1 to inform the person 102 about the location of their luggage, as further described with respect to FIG. 2-2. Other examples are also possible in which the person 102 attaches the first travel device 108-1 to other types of objects, such as a child's backpack or shoe, a laptop, a stroller, a vehicle, or a package.

In a second example situation, the contextual travel summary 106 provides the person 102 peace of mind by providing travel updates regarding a person 204 who is known by the person 102. Consider the environment 200-2 in which the person 204 travels with a second travel device 108-2. The interface device 110 can generate a contextual travel summary 106 based on the travel information provided by the second travel device 108-2 to inform the person 102 about the current location of the person 204 relative to a known landmark, how the person 204 is traveling, and/or when the person 204 is estimated to arrive at their destination, as further described with respect to FIG. 2-2.

In a third example situation, the contextual travel summary 106 provides the person 102 an update on an activity regarding a pet, such as a dog or a cat. With this information, the person 102 can determine if the pet has had sufficient exercise, can find a lost pet, or can determine if the pet was walked by a pet sitter. Consider the environment 200-3 in which a pet 206 (a dog in this example) is wearing a third travel device 108-3. The interface device 110 can generate a contextual travel summary 106 based on the travel information provided by the third travel device 108-3 to inform the person 102 about the current location of the pet 206, where the pet 206 is being walked, an intensity level of a walk or play session, and/or when the pet 206 is estimated to be returned home, as further described with respect to FIG. 2-2.

FIG. 2-2 illustrates an example notification application 208 running on the interface device 110. Through the notification application 208, the person 102 receives notifications regarding the contextual travel summary 106 associated with the travel devices 108-1, 108-2, and 108-3 described in FIG. 2-1. As the travel situation changes for any of the travel devices 108-1 to 108-3, the interface device 110 can present a new notification to the person 102 that provides an updated contextual travel summary 106.

For the example environment 200-1 in FIG. 2-1, the notification application 208 provides, over time, two example notifications 210-1 and 210-2 regarding the current travel information associated with the first travel device 108-1. In this example, the notifications 210-1 and 210-2 inform the person 102 about the location of their luggage.

For the example environment 200-2 in FIG. 2-1, the notification application 208 provides, over time, two example notifications 212-1 and 212-2 regarding the current travel situation of the person 204, who is carrying the second travel device 108-2. In this example, the notifications 212-1 and 212-2 inform the person 102 about the current location of the person 204 (e.g., “at the bus stop near school” and “just passed by the mall”), how they are traveling (e.g., by “bus”), and an impact to the person 204's arrival home (e.g., “a nearby accident is causing a 10 minute delay).

For the example environment 200-3 in FIG. 2-1, the notification application 208 provides, over time, two example notifications 214-1 and 214-2 regarding the current travel situation of the pet 206, which wears the third travel device 108-3. In this example, the notifications 214-1 and 214-2 informs the person 102 about where the pet is (e.g., “at the nearby park” and “resting at home”), the degree of exercise intensity (e.g., “running around”) and a total duration of the outing (e.g., “a thirty minute walk and play session at the park”).

In the examples described in FIGS. 1-1 to 1-2, a communication application 112 running on the device 104 automatically generates the contextual travel summary 106 in response to the device 104 receiving a message 114. In the examples described in FIGS. 2-1 to 2-2, the notification application 208 running on the interface device 110 automatically generates the contextual travel summary 106 when there is a significant change or an important update in the travel information associated with a travel device 108. Other examples are also possible in which the interface device 110 can use the contextual travel summary 106 to provide a short status highlight for multiple travel devices 108 corresponding to different people, as further described with respect to FIGS. 3-1 and 3-2.

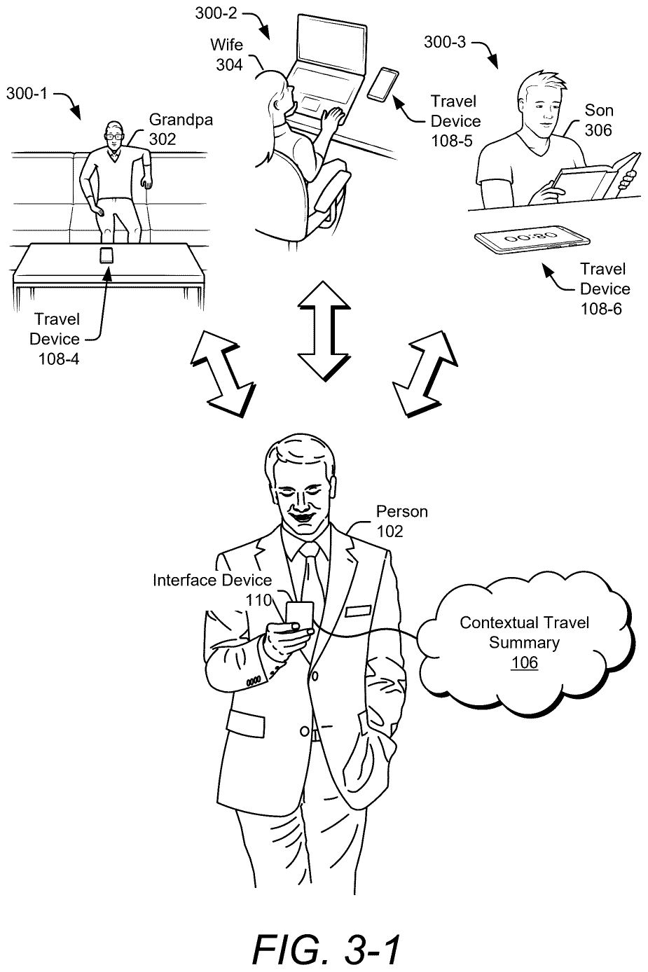

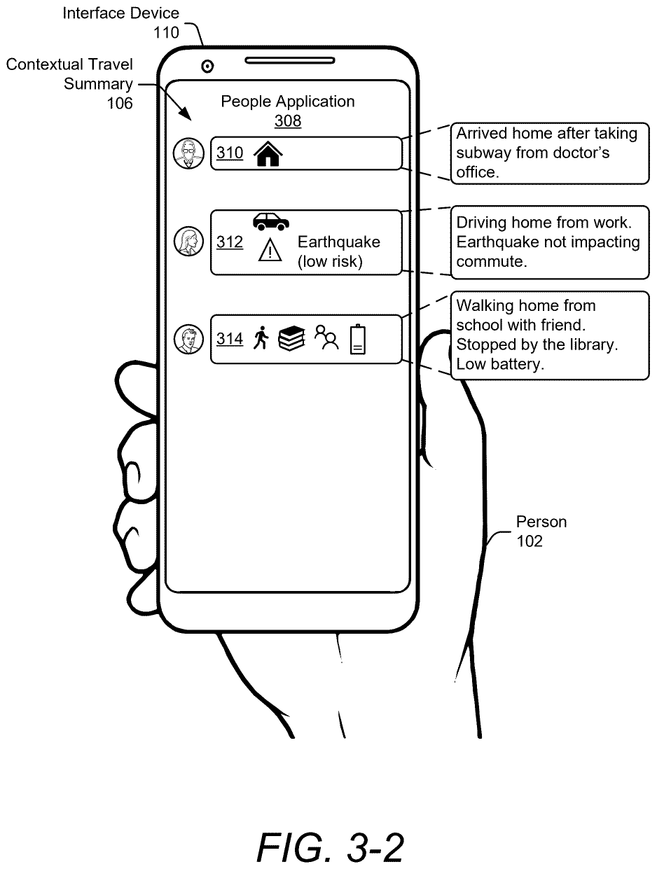

FIG. 3-1 is an illustration of example environments 300-1, 300-2, and 300-3 in which different travel devices 108-4, 108-5, and 108-6 are in communication with the interface device 110. In these examples, the travel devices 108-4, 108-5, and 108-6 are associated with different people who are known to the person 102. Consider a situation in which multiple members of the person 102's family have a travel device 108. The person 102's grandpa 302 in environment 300-1 can own or have access to the travel device 108-4. A wife 304 of the person 102 in environment 300-2 owns or has access to the travel device 108-5. The person 102's son 306 in environment 300-3 owns or has access to the travel device 108-6. The travel devices 108-4, 108-5, and 108-6 have received permission to communicate travel information with the interface device 110. With this travel information, the interface device 110 can present a shortened or condensed contextual travel summary 106 that provides a quick highlight regarding the travel situation of each of these individuals, as further described with respect to FIG. 3-2.

FIG. 3-2 illustrates an example people application 308 running on the interface device 110. Through the people application 308, the person 102 receives the current contextual travel summary 106 regarding the people associated with the travel devices 108-4 to 108-6. In this example, the contextual travel summary 106 is presented in a short or condensed format, such as using a few words and/or images (e.g., status icons). With the people application 308, the person 102 can quickly get the highlights regarding the location and/or travel information regarding each family member. The status icons can be presented next to an identifier (e.g., an image or a name) of the corresponding person. In some implementations, the person 102 can select the status associated with a person to get further details (e.g., a more in-depth representation of the contextual travel summary 106 that includes one or more sentences).

The status 310 of the grandpa 302's travel situation, for example, includes an image of a house to indicate that the grandpa 302 is currently at home. By clicking on the status 310, the interface device 110 can present additional information that reads “Arrived home after taking subway from doctor's office.” The status 312 of the wife 304's travel situation can include an image of a car to indicate that the wife 304 is currently driving. The status 312 can also indicate a warning symbol and text that reads “Earthquake (low risk).” By clicking on the status 312, the interface device 110 can present additional information about the contextual travel summary 106 that reads “Driving home from work. Earthquake not impacting commute.” The status 314 of the son 306's travel situation can include multiple images such as an image of a person walking, an image of multiple books, an image of two people, and an image of a low battery. By clicking on the status 314, the interface device 110 can present additional information that reads “Walking home from school with friend. Stopped by the library. Low battery.”

Similar to the notification application 208, the people application 308 can automatically and continuously update the statuses associated with each person based on a determination that there has been a significant change or an important update in the corresponding contextual travel summary 106. In general, the contextual travel summary 106 can include more details beyond a current geographical location of the travel device 108 and/or an estimated arrival of the travel device 108, as further described with respect to FIG. 4.

FIG. 4 illustrates example types of information that can be provided by a contextual travel summary 106, including a utilized mode of transportation 402, information regarding situations that have an impact on travel (impact to travel 404), information about an environment 406 that is traversed, information about a status 408 of the travel device 108 or a status 408 of a vehicle that is utilized for the mode of transportation 402, and/or information about the presence or absence of a travel companion 410.

The mode of transportation 402 can indicate whether the travel device 108 is being transported by an airplane, a train, a boat, a bus, a subway, a car, a motorcycle, a bicycle, a horse, or a person (e.g., the person 102 or the person 204). In generating the contextual travel summary 106, the mode of transportation 402 can be used to determine potential impacts to travel 404 that are relevant to a given travel situation and/or to determine relevant status 408 information. Including the mode of transportation 402 in the contextual travel summary 106 can also make it easy for an authorized recipient of the contextual travel summary 106 to quickly understand which route a person 102 or 204 is likely to take, how fast they are likely to arrive at their destination, and a degree of risk associated with the travel situation.

Information about the impact to travel 404 can include information about any delays or events that impact a given travel situation. Example impacts to travel 404 can include train delays, road traffic, a traffic accident, detours, reduced speed areas due to construction, inclement weather (e.g., fog, rain, or snow), or an occurrence of a natural disaster (e.g., an earthquake). Other impacts to travel 404 can include any intermediate stops that are made on the way to the intended destination. Example stops can include the person 102 or 204 going to a store, getting fast food, or spending time at a friend's house. Other stops may be related to addressing an issue with the mode of transportation 402, such as fixing a flat tire or resupplying a vehicle with power (e.g., recharging a battery or refilling a gas tank). Sometimes an impact to travel 404 is due to the person 102 or 204 having to go back and retrieve an object that was accidentally left behind (e.g., keys, a watch, a wallet, or a stroller). By including any impacts to travel 404 in the contextual travel summary 106, an authorized recipient can better understand if the person 102 or 204 is running late, why they are running late, and how likely their current estimated arrival is likely to change.

In some implementations, the interface device 110 can reference the mode of transportation 402 to determine the type of information to access or compile for assessing impacts to travel 404. For example, if the person 102 or 204 is traveling by train, the device 104 can analyze information about train schedules to determine if any train delays may impact the estimated arrival time. As another example, if the person 102 is walking, the device 104 can analyze information about the weather to determine if the travel time is likely to be impacted. In yet another example, if the person 102 or 204 is driving a vehicle (e.g., a car), the device 104 can analyze information about traffic or road construction to determine if there are any impacts to the travel time.

The information about the environment 406 can include landmarks that are near to a current location of the travel device 108, cellular coverage availability, and/or street safety conditions. With information about nearby landmarks, it can be easier for a recipient of the contextual travel summary 106 to comprehend where the person 102 or 204 is in relation to their destination. Example landmarks can include a historical building, a government building, a statue, a well-known store, a natural or man-made feature in the landscape (e.g., a lake, a river, or a mountain), a point of interest (e.g., a tree or a park), or a location that is known by the recipient (e.g., a nearby location that is in the person's contact list or list of pinned locations). The availability of cellular coverage can indicate if there will be challenges in communicating with the travel device 108 if it supports cellular communication. The street safety conditions can indicate a level of safety associated with traveling. For a road, the street safety conditions can indicate whether the road is reported to have potholes or is reported to be slippery due to ice. For a walking path or a hiking trail, the street safety conditions can indicate whether the path is reported to be flooded or in disrepair. Other safety information about the environment 406 can be based on an amount of crime associated with a given location.

The status 408 can include a status of the device 104 itself (e.g., a power level of the device 104). Consider a situation in which the status 408 indicates that the battery level of the travel device 108 is low. With this information, a recipient of the contextual travel summary 106 may decide to text the person 102 or 204 instead of calling the person 102 or 204 to avoid depleting the travel device 108's battery. By generating the contextual travel summary 106, the device 104 can make it easy for the acquaintance or the person 102 to understand a travel situation involving an entity (e.g., the person 102, the person 204, or the object 202). Other statuses 408 can be related to the vehicle used in the mode of transportation 402 (e.g., a state of the vehicle's tires or a state of the vehicle's available power). In this case, the travel device 108 can communicate with the vehicle and forward the status information about the vehicle to the interface device 110. The interface device 110 can incorporate any status information about the vehicle into the generation of the contextual travel summary 106.

The presence or absence of a travel companion 410 can indicate if the person 102 or 204 is traveling alone or with an acquaintance. In this case, the person 102 or 204 and the acquaintance have given prior permission for their travel devices 108 to communicate with each other. If the travel device 108 determines that it is near another device associated with the acquaintance, the travel device 108 can forward this information to the interface device 110. The interface device 110 can incorporate the information about the travel companion 410 into the generation of the contextual travel summary 106.

### Generating a Contextual Travel Summary

FIG. 5 illustrates an example device 104 capable of performing aspects of generating the contextual travel summary 106. The device 104 is illustrated with various non-limiting example devices including a laptop 104-1, a tablet 104-2, hearables 104-3, a computing watch 104-4, a gaming system 104-5, computing glasses 104-6, and a vehicle 104-7. Other devices may also be used, including a drone, a trackpad, a drawing pad, a netbook, or an e-reader. Note that the computing device 104 can be wearable or non-wearable but mobile.

The device 104 includes at least one location-finding system 502. The location-finding system 502 determines a location of the device 104. Example location-finding systems 502 can include a global navigation satellite system, a cellular positioning system, a Wi-Fi® positioning system, or a Bluetooth® positioning system. The global navigation satellite system can be designed to support any type of satellite navigation system, including the United States'Global Positioning System (GPS), Russia's Global Navigation Satellite System (GLONASS), China's BeiDou Navigation Satellite System (BDS), the European Union's Galileo, and so forth.

The computing device 104 includes one or more computer processors 504 and at least one computer-readable medium 506 (e.g., non-transitory computer-readable medium), which includes memory media and storage media. Applications and/or an operating system (not shown) embodied as computer-readable instructions on the computer-readable medium 506 can be executed by the computer processor 504 to provide some of the functionalities described herein. Example applications can include one or more of the applications 112, 208, and/or 308 described with respect to FIGS. 1-2, 2-2, and 3-2. The computer-readable medium 506 also includes a contextual travel summary generator 508, which uses information provided by at least the location-finding system 502 to generate the contextual travel summary 106. The contextual travel summary generator 508 can be implemented using at least one machine-learned model 510.

The machine-learned model 510 includes at least one neural network. A neural network includes a group of connected nodes (e.g., neurons or perceptrons), which are organized into one or more layers. As an example, the machine-learned model 510 includes a deep neural network, which includes an input layer, an output layer, and one or more hidden layers positioned between the input layer and the output layer. The nodes of the deep neural network can be partially connected or fully connected between the layers.

In some cases, the deep neural network is a recurrent deep neural network (e.g., a long short-term memory (LSTM) recurrent deep neural network) with connections between nodes forming a cycle to retain information from a previous portion of an input data sequence for a subsequent portion of the input data sequence. In other cases, the deep neural network is a feed-forward deep neural network in which the connections between the nodes do not form a cycle. Additionally or alternatively, the machine-learned model 510 can include another type of neural network (e.g., a convolutional neural network).

In some cases, the machine-learned model 510 is implemented using a large-language model (LLM) 512. The large-language model 512 can be an existing large-language model with additional training in some implementations. In other implementations, the large-language model 512 can be a general large-language model, which is not specifically trained to generate the contextual travel summary 106 based on travel information. Example large-language models 512 include LaMDA GLM, Chat GPT, Gopher, Chinchilla, Gemini, PaLM, or a similar large-language model.

The machine-learned model 510 (e.g., the large-language model 512) can be trained using supervised learning techniques. For example, the machine-learned model 510 can be trained on a training dataset that includes training examples labeled as belonging (or not belonging) to different travel situations. In some cases, the machine-learned model 510 can have additional training on specific data types, including specific types of data that correspond to the travel situation (e.g., the mode of transportation 402, the impact to travel 404, the environment 406, the status 408, and/or the travel companion 410). These specific data types can be, for example, labeled data sets including the data associated with the travel situation and a description portion. The specific data types can also include unlabeled data sets. In some examples, a transformer algorithm can be used to train the large-language model 512 by processing entire sequences in parallel, as opposed to sequential processing of inputs.

The device 104 can also include a network interface 514 for communicating data over wired, wireless, or optical networks. For example, the network interface 514 may communicate data over a local-area-network (LAN), a wireless local-area-network (WLAN), a personal-area-network (PAN), a wire-area-network (WAN), an intranet, the Internet, a peer-to-peer network, point-to-point network, a mesh network, Bluetooth®, and the like. The computing device 104 may also include a display 516, which can be used to present the contextual travel summary 106 to the person 102.

Although the components in FIG. 5 are shown to be incorporated into a single device 104, it is to be understood that other implementations can incorporate some of the components within the travel device 108 and other components within the interface device 110. For example, the travel device 108 can include the location-finding system 502 and the network interface 514. The interface device 110 can include the computer processor 504, the contextual-travel summary generator 508, the network interface 514, and/or the display 516. In some implementations, the device 104 or the travel device 108 includes one or more sensors, such as an accelerometer, a radar sensor, an ultrasound sensor, a light sensor, a temperature sensor, a magnetometer, a camera, or a heart-rate monitor. The device 104 or the travel device 108 can use various types of sensors to provide travel information regarding the mode of transportation 402 or the environment 406, as further described with respect to FIG. 6.

FIG. 6 illustrates example types of travel information 602 that can be used to generate a contextual travel summary 106. During operation, the contextual travel summary generator 508 receives the travel information 602 and generates the contextual travel summary 106 based on the travel information 602. In the depicted configuration, the contextual travel summary generator 508 is communicatively coupled to other components of the device 104, the travel device 108, and/or the interface device 110. In some situations, the contextual travel summary generator 508 is also communicatively coupled to a vehicle 604 associated with transporting the device 104 (or the travel device 108). In general, the device 104, the travel device 108, the interface device 110, and/or the vehicle 604 can generate the travel information 602, which can include a variety of different types of data associated with one or more of the mode of transportation 402, the impact to travel 404, the environment 406, the status 408, and/or the travel companion 410.

The contextual travel summary 106 represents a compilation of the travel information 602, which is presented in a natural language that can be readily understood by a human (e.g., the person 102). In example implementations, the contextual travel summary 106 can be presented using text and/or images. In some cases, the contextual travel summary 106 can comprise multiple sentences, such as in the example shown in FIG. 1-2. In other cases, the contextual travel summary 106 can be a single sentence, as in some of the examples shown in FIG. 2-2. In still other cases, the contextual travel summary 106 can be presented using a few words and/or using one or more images or status symbols, as in the examples shown in FIG. 3-2.

Example components of the device 104 (or the travel device 108) include the location-finding system 502, a mode-of-transportation detector 606, a status reporter 608, and a companion finder 610. The location-finding system 502 can provide information regarding a location of the device 104 (or of the travel device 108) to the contextual travel summary generator 508.

The mode-of-transportation detector 606 determines how the device 104 (or the travel device 108) is being transported. In particular, the mode-of-transportation detector 606 generates data associated with the mode of transportation 402. With various sensors and/or information from the location-finding system 502, the mode-of-transportation detector 606 can determine that the device 104 (or the travel device 108) is being transported by the vehicle 604 (e.g., an airplane, a car, a train, or a bicycle) or by a person (e.g., by a person who is walking or running). In some implementations, the mode-of-transportation detector 606 can determine the type of vehicle used to transport the device 104 (or the travel device 108).

The status reporter 608 reports a status 408 of the device 104 (or the travel device 108). Example types of statuses 408 can include a battery level, a connectivity status, or a connectivity quality. The companion finder 610 determines if the device 104 (or the travel device 108) is within proximity of another device that is associated with a known contact of the person 102 or 204 that owns the device 104 (or the travel device 108). This determination can be made based on the devices sharing location information and/or based on the devices establishing some form of short-range communication (e.g., using Bluetooth® or near-field communication (NFC)).

In some implementations, the contextual travel summary generator 508 also receives travel information 602 associated with the vehicle 604. In this example, the vehicle 604 includes a status reporter 612, which can directly report the status of the vehicle 604 to the contextual travel summary generator 508. Other implementations are also possible in which the vehicle 604 reports its status to the travel device 108, which forwards the information to the contextual travel summary generator 508 running on the interface device 110. Example vehicle-based statuses 408 can include a tire pressure or available power resources (e.g., a battery level of an electric vehicle or a gasoline level of a gasoline-powered vehicle). With this information, the contextual travel summary generator 508 can determine whether additional delays are likely to occur in order to address problems with the vehicle 604 (e.g., a low tire pressure or a low fuel level).

The device 104 (or the interface device 110) can include a context resolver 614, which accesses information for identifying an impact to travel 404 and/or for determining information about the environment 406. For example, the context resolver 614 can access the Internet to look up information regarding train schedules, weather, traffic conditions, nearby landmarks, and so forth. In some implementations, the context resolver 614 can use information about the device 104's (or the travel devices 108's) location and/or information about the mode of transportation 402 to determine the type of information that is helpful to compile and pass to the contextual travel summary generator 508.

In some implementations, the person 102 or 204 can grant the context resolver 614 access to additional information, including a contact list, a list of pinned locations, or calendar events. With this access, the context resolver 614 can further determine impacts to travel 404. For example, the context resolver 614 can estimate that the person 102 or 204 may be delayed arriving home due to an upcoming doctor's visit or due to a need to pick up an online food order.

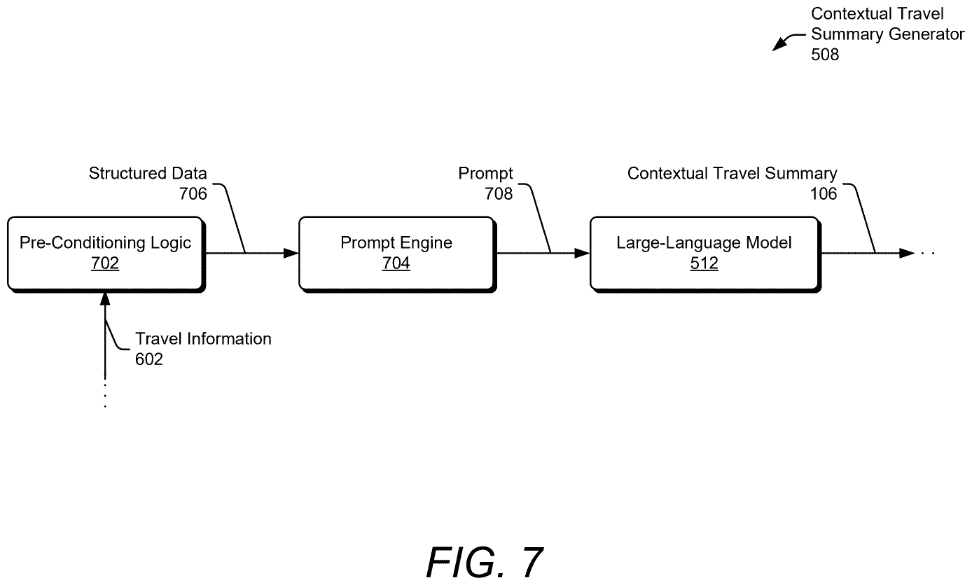

In some implementations, the location-finding system 502, the mode-of-transportation detector 606, the status reporter 608, the companion finder 610, and/or the context resolver 614 are implemented at an operating-system level to protect a privacy of the person 102 or 204. An example implementation of the contextual travel summary generator 508 is further described with respect to FIG. 7.

FIG. 7 illustrates an example implementation of the contextual travel summary generator 508. In the depicted configuration, the contextual travel summary generator 508 includes pre-conditioning logic 702, a prompt engine 704, and the large-language model 512. The prompt engine 704 is coupled between the pre-conditioning logic 702 and the large-language model 512.

During operation, the pre-conditioning logic 702 selects which travel information 602 to use for generating the contextual travel summary 106. The pre-conditioning logic 702 generates structured data 706 based on this selection. The structured data 706 is in a format that can be readily processed by the prompt engine 704. In some implementations, the pre-conditioning logic 702 can select portions of the travel information 602 that are new or have changed since a previous generation of the contextual travel summary 106.

In some cases, the pre-conditioning logic 702 can compare the current travel information 602 to past travel information 602 to determine if there has been a significant change to the travel situation. If there has not been a significant change, the pre-conditioning logic 702 can prevent the generation of the contextual travel summary 106. If there has been a significant change, the pre-conditioning logic 702 can enable the generation of the contextual travel summary 106. In this way, the pre-conditioning logic 702 can be the gate-keeper for determining when the contextual travel summary 106 is to be updated. Significant changes can include changes to any of the elements associated with the contextual travel summary 106 (e.g., changes to the mode of transportation 402, the impact to travel 404, the environment 406, the status 408 of the device 104 or the vehicle 604, or a change in the presence or absence of the travel companion 410). In general, the significant change is not directly determined based on a change in a location of the travel device 108. In some cases, the person 102 or the recipient of the contextual travel summary 106 can identify or select which elements of the contextual travel summary 106 are to be considered for enabling and/or preventing the generation of the contextual travel summary 106.

The prompt engine 704 generates a prompt 708 based on the structured data 706. The prompt 708 can include information from the structured data 706 as well as instructions for formatting the contextual travel summary 106. By appropriately formulating the prompt 708, the prompt engine 704 enables the large-language model 512 to generate a contextual travel summary 106 that is helpful for understanding the travel situation associated with the person 102 or 204 or the object 202.

In some implementations, the prompt engine 704 can receive additional information about an intended purpose of the contextual travel summary 106. This information can be previously provided by the person 102 or by an application that is requesting the contextual travel summary 106. For example, the communication application 112 in FIG. 1-2 can instruct the prompt engine 704 to generate a first prompt 708 that causes the large-language model 512 to generate a contextual travel summary 106 that can be used as a suggested response to the received message 114. The notification application 208 of FIG. 2-2 can cause the prompt engine 704 to generate a second prompt 708 that causes the large-language model 512 to generate the contextual travel summary 106 in a manner that assists the person 102 with tracking the location of their luggage based on the travel information 602 provided by the first travel device 108-1, monitoring the travel situation of the person 204 based on the travel information 602 provided by the second travel device 108-2, and/or determining a level of exercise the pet 206 received based on the travel information 602 provided by the third travel device 108-3. The people application 308 of FIG. 3-2 can instruct the prompt engine 704 to generate a third prompt 708 that causes the large-language model 512 to generate high-level status information about the travel situations of family members. In general, the generation of the contextual travel summary 106 can be further customized or tailored via the prompt engine 704 based on the intended use of the contextual travel summary 106 for a given situation.

Other implementations of the contextual travel summary generator 508 are also possible. In a first example, the contextual travel summary generator 508 can be implemented without the pre-conditioning logic 702. In this case, the prompt engine 704 and/or the large-language model 512 can be trained to process the travel information 602 directly. In a second example, the contextual travel summary generator 508 can be implemented without the pre-conditioning logic 702 and without the prompt engine 704. In this case, the person 102 and/or an application can provide a prompt 708 to the large-language model 512.

### Example Method

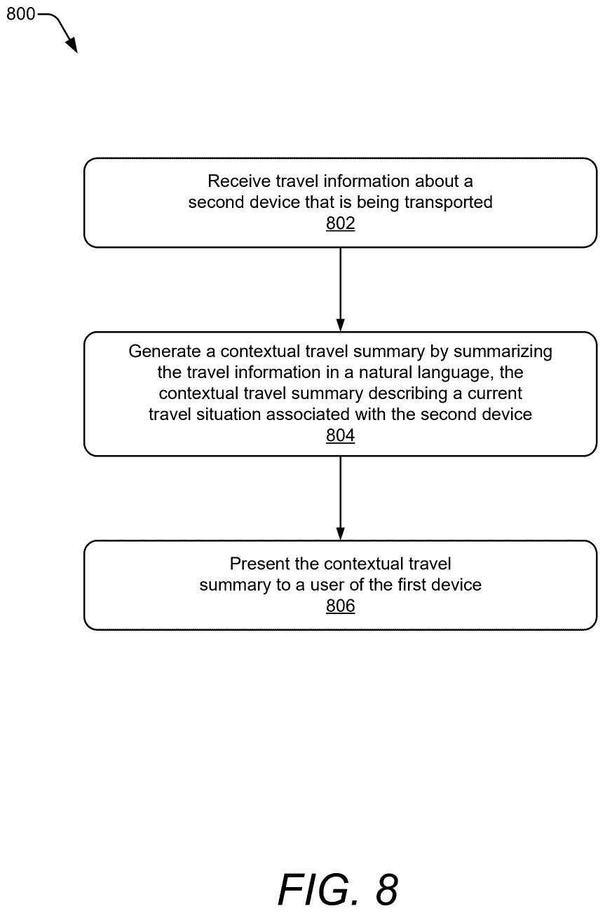

FIG. 8 depicts an example method 800 for implementing aspects of generating a contextual travel summary 106. Method 800 is shown as sets of operations (or acts) performed but not necessarily limited to the order or combinations in which the operations are shown herein. Further, any of one or more of the operations may be repeated, combined, reorganized, or linked to provide a wide array of additional and/or alternate methods. In portions of the following discussion, reference may be made to the environments of FIGS. 1-1, 2-1, or 3-1, and entities detailed in FIG. 5, reference to which is made for example only. The techniques are not limited to performance by one entity or multiple entities operating on one device.

At 802, travel information about a second device that is being transported is received by a first device. For example, the device 104 receives the travel information 602 about a second device that is being transported. In a first example situation, the second device can represent the device 104 itself, which may be transported by the person 102 as shown in FIG. 1-1. In other example situations, the second device is a travel device 108, which is another device that is separate or distinct from the first device. In a second example situation, the second device is used by the person 102 to track a location of an object 202, as shown in FIG. 2-1. In a third example situation, the second device is used by another person 204 and enables the person 102 to monitor the person 204's travel situation, as shown in FIG. 2-1.

The travel information 602 can include data associated with the mode of transportation 402, an impact to travel 404, the environment 406, the status 408 of the second device or a vehicle 604, and/or the presence (or absence) of a travel companion 410. In general, the travel information 602 can be generated based on location information provided by the location-finding system 502, based on information provided by one or more sensors of the device 104 or the travel device 108, based on information provided by the vehicle 604, and/or based on information that is accessed by the context resolver 614, as shown in FIG. 6.

At 804, a contextual travel summary is generated by summarizing the travel information in a natural language. The contextual travel summary describes a current travel situation associated with the second device. For example, the contextual travel summary generator 508 generates the contextual travel summary 106 by summarizing the travel information 602 in a natural language, as shown in FIG. 6. The contextual travel summary 106 is an easy-to-understand description of a travel situation that involves the second device (e.g., the device 104 or the travel device 108).

At 806, the contextual travel summary is presented to a user of the first device. For example, the device 104 presents the contextual travel summary 106 to the person 102. The contextual travel summary 106 can be presented as a suggested response in a communication application 112 in some situations, as described with respect to FIG. 1-2. In other situations, the contextual travel summary 106 can be presented as an alert or as a notification, as described in FIG. 2-2. In still other situations, the contextual travel summary 106 can be presented using status icons that are positioned next to identifiers of individuals that are associated with the contextual travel summary 106, as shown in FIG. 3-2.

### Example Computing System

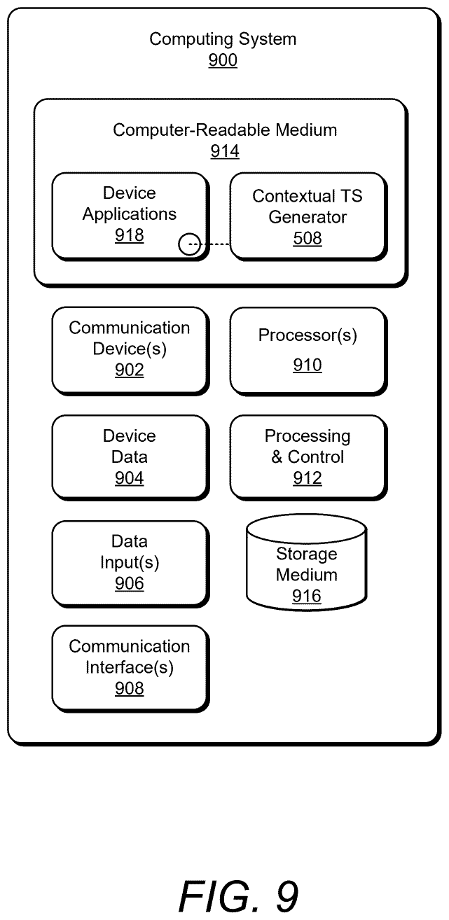

FIG. 9 illustrates various components of an example computing system 900 that can be implemented as any type of client, server, and/or computing device as described with reference to the previous FIG. 3 to implement aspects of generating a contextual travel summary 106.

The computing system 900 includes communication devices 902 that enable wired and/or wireless communication of device data 904 (e.g., received data, data that is being received, data scheduled for broadcast, or data packets of the data). The device data 904 or other device content can include configuration settings of the device, media content stored on the device, and/or information associated with a user of the device. Media content stored on the computing system 900 can include any type of audio, video, and/or image data. The computing system 900 includes one or more data inputs 906 via which any type of data, sensor data, and/or inputs can be received, including information associated with the travel information 602.

The computing system 900 also includes communication interfaces 908, which can be implemented as any one or more of a serial and/or parallel interface, a wireless interface, any type of network interface, a modem, and as any other type of communication interface. The communication interfaces 908 provide a connection and/or communication links between the computing system 900 and a communication network by which other electronic, computing, and communication devices communicate data with the computing system 900.

The computing system 900 includes one or more processors 910 (e.g., any of microprocessors, controllers, and the like), which process various computer-executable instructions to control the operation of the computing system 900. Alternatively or in addition, the computing system 900 can be implemented with any one or combination of hardware, firmware, or fixed logic circuitry that is implemented in connection with processing and control circuits which are generally identified at 912. Although not shown, the computing system 900 can include a system bus or data transfer system that couples the various components within the device. A system bus can include any one or combination of different bus structures, including a memory bus or memory controller, a peripheral bus, a universal serial bus, and/or a processor or local bus that utilizes any of a variety of bus architectures.

The computing system 900 also includes a computer-readable medium 914, such as one or more memory devices that enable persistent and/or non-transitory data storage (i.e., in contrast to mere signal transmission), examples of which include random access memory (RAM), non-volatile memory (e.g., any one or more of a read-only memory (ROM), flash memory, EPROM, EEPROM, etc.), and a disk storage device. The disk storage device may be implemented as any type of magnetic or optical storage device, such as a hard disk drive, a recordable and/or rewriteable compact disc (CD), any type of a digital versatile disc (DVD), and the like. The computing system 900 can also include a mass storage medium device (storage medium) 916.

The computer-readable medium 914 provides data storage mechanisms to store the device data 904, as well as various device applications 918 and any other types of information and/or data related to operational aspects of the computing system 900. For example, an operating system, the communication application 112, the notification application 208, and/or the people application 308 can be maintained as a computer application with the computer-readable medium 914 and executed on the processors 910. The device applications 918 may include a device manager, such as any form of a control application, software application, signal-processing and control module, code that is native to a particular device, a hardware abstraction layer for a particular device, and so on.

The device applications 918 also include any system components, engines, or managers for generating a contextual travel summary 106. In this example, the device applications 918 include the contextual travel summary generator 508 of FIG. 5, which can be implemented using a machine-learned model 510 and/or a large-language model 512.

Throughout this disclosure, examples are described where a computing system 900 (e.g., the device 104, the travel device 108, the interface device 110, a client device, a server device, a computer, or another type of computing system) may analyze information (e.g., various location information) associated with a person 102 or 204, for example. Further to the descriptions above, a person 102 or 204 may be provided with controls allowing the person 102 or 204 to make an election as to both if and when systems, programs, and/or features described herein may enable collection of information (e.g., information about a current location of the person 102 or 204, schedule, contacts, pinned locations, and/or mode of transportation), and if the person 102 or 204 is sent content or communications from a server. The computing system 900 can be configured to only use the information after the computing system 900 receives explicit permission from the person 102 or 204 to use the information. For example, in situations where the device 104 or the interface device 110 generates the contextual travel summary 106, individual people 102 or 204 may be provided with an opportunity to provide input to control whether programs or features of the computing system 900 can collect and make use of the information. Further, individual people 102 or 204 may have constant control over what programs can or cannot do with the information.

In addition, information collected may be pre-treated in one or more ways before it is transferred, stored, or otherwise used, so that personally-identifiable information is removed, secured, and/or protected. For example, before the computing system 900 shares information with another device, an identity of the person 102 or 204 or an identity of the travel companion 410 may be treated so that no personally-identifiable information can be determined. Thus, the person 102, 204, or 410 may have control over whether information is collected about the person 102, 204, or 410 and the device (e.g., the travel device 108) of the person 102, 204, or 410, and how such information, if collected, may be used by the computing system 900 and/or a remote computing system.

### Conclusion

Although techniques using, and apparatuses including, generating a contextual travel summary have been described in language specific to features and/or methods, it is to be understood that the subject of the appended claims is not necessarily limited to the specific features or methods described. Rather, the specific features and methods are disclosed as example implementations of generating a contextual travel summary.

Some examples are further described below.

Example 1: A method performed by a first device, the method comprising:
receiving travel information about a second device that is being transported;
generating a contextual travel summary by summarizing the travel information in a natural language, the contextual travel summary describing a current travel situation associated with the second device; and
presenting the contextual travel summary to a user of the first device.

Example 2: The method of example 1, further comprising:
after the presenting of the contextual travel summary, receiving additional travel information about the second device that is being transported, the travel information representing first travel information and the additional travel information representing second travel information;
determining, based on a comparison of the second travel information to the first travel information, that there has been a change in the current travel situation associated with the second device;
generating, based on the determination, a second contextual travel summary by summarizing the additional travel information; and
presenting the second contextual travel summary to the user of the first device.

Example 3: The method of example 2, further comprising:
after the presenting of the second contextual travel summary, receiving third travel information about the second device that is being transported;
determining, based on a comparison of the third travel information to the second travel information, that there has not been a change in the current travel situation associated with the second device; and
preventing, based on the determination that there has not been a change in the current travel situation, generation of a third contextual travel summary based on the third travel information.

Example 4: The method of any prior example, wherein the contextual travel summary comprises information about at least one of the following:
a mode of transportation involved in transporting the second device;
an impact to the current travel situation;
an environment through which the second device is transported;
a status of the second device;
a status of a vehicle that is involved in transporting the second device; or
a presence of a travel companion.

Example 5: The method of example 4, wherein:
the contextual travel summary comprises at least the information about the mode of transportation and the impact to the current travel situation; and
the impact to the current travel situation comprises information related to a delay corresponding to the mode of transportation.

Example 6: The method of example 4 or 5, wherein:
the contextual travel summary comprises at least the information about the environment; and
the information about the environment comprises information about at least one of the following:
   a landmark that is near a current location of the second device;
   cellular coverage availability relating to the current location of the second device; or
   street safety conditions relating to the current location of the second device.

Example 7: The method of any prior example, further comprising:
receiving a message via a communication application, the message inquiring about the current travel situation associated with the second device, wherein:
the first device and the second device represent a same device; and
the presenting of the contextual travel summary comprises providing, via the communication application, the contextual travel summary as a suggested response to the received message.

Example 8: The method of example 7, further comprising:
enabling the suggested response to be edited by the user prior to transmitting the suggested response via the communication application; and
prompting the user to approve the suggested response prior to transmitting the suggested response via the communication application.

Example 9: The method of example 7 or 8, wherein the generating of the contextual travel summary further comprises generating the contextual travel summary by prompting a large-language model to generate a response to the received message based on the travel information provided to the large-language model.

Example 10: The method of any prior example, wherein the first device and the second device represent different devices.

Example 11: The method of example 10, wherein the second device comprises a travel device that is attached to, integrated within, or placed within an object.

Example 12: The method of example 10, wherein the second device comprises a travel device that is carried by another person, the other person being someone other than the user.

Example 13: The method of example 12, wherein the presenting of the contextual travel summary to the user comprises presenting, via the first device, one or more status symbols next to an identifier of the other person.

Example 14: The method of any prior example, wherein the contextual travel summary further comprises a selectable link to a digital map indicating a current location of the second device.

Example 15: A computer-readable storage medium comprising instructions that, responsive to execution by a processor of a first device, cause the processor to:
receive travel information about a second device that is being transported;
generate a contextual travel summary by summarizing the travel information in a natural language, the contextual travel summary describing a current travel situation associated with the second device; and
present the contextual travel summary to a user of the first device.

Example 16: The computer-readable storage medium of example 15, wherein the instructions cause the processor to:
receive, after the contextual travel summary is presented, additional travel information about the second device that is being transported, the travel information representing first travel information and the additional travel information representing second travel information;
determine, based on a comparison of the second travel information to the first travel information, that there has been a change in the current travel situation associated with the second device;
generate, based on the determination, a second contextual travel summary by summarizing the additional travel information; and
present the second contextual travel summary to the user of the first device.

Example 17: The computer-readable storage medium of example 15 or 16, wherein the instructions cause the processor to:
receive, after the second contextual travel summary is presented, third travel information about the second device that is being transported;
determine, based on a comparison of the third travel information to the second travel information, that there has not been a change in the current travel situation associated with the second device; and
prevent, based on the determination that there has not been a change in the current travel situation, a generation of a third contextual travel summary based on the third travel information.

Example 18: An apparatus comprising:
a computer processor configured to:
   receive travel information about a transportation of the apparatus;
   generate a contextual travel summary by summarizing the travel information in a natural language, the contextual travel summary describing a current travel situation associated with the apparatus; and
   present the contextual travel summary to a user of the apparatus.

Example 19: The apparatus of example 18, further comprising:
a network interface configured to receive a message inquiring about the current travel situation of the user of the apparatus,
wherein the computer processor is further configured to provide the contextual travel summary as a suggested response to the received message.

Example 20: The apparatus of example 19, wherein:
the network interface is configured to transmit a version of the suggested response as a response to the received message; and
the computer processor is further configured to:
   enable the suggested response to be edited by the user prior to transmission of the response; and
   prompt the user to approve the suggested response prior to the transmission of the response.

What is claimed is:

1. A method performed by a first device, the method comprising:
receiving travel information about a second device that is being transported;
generating a contextual travel summary by summarizing the travel information in a natural language, the contextual travel summary describing a current travel situation associated with the second device; and
presenting the contextual travel summary to a user of the first device.

2. The method of claim 1, further comprising:
after the presenting of the contextual travel summary, receiving additional travel information about the second device that is being transported, the travel information representing first travel information and the additional travel information representing second travel information;
determining, based on a comparison of the second travel information to the first travel information, that there has been a change in the current travel situation associated with the second device;
generating, based on the determination, a second contextual travel summary by summarizing the additional travel information; and
presenting the second contextual travel summary to the user of the first device.

3. The method of claim 2, further comprising:
after the presenting of the second contextual travel summary, receiving third travel information about the second device that is being transported;
determining, based on a comparison of the third travel information to the second travel information, that there has not been a change in the current travel situation associated with the second device; and
preventing, based on the determination that there has not been a change in the current travel situation, generation of a third contextual travel summary based on the third travel information.

4. The method of claim 1, wherein the contextual travel summary comprises information about at least one of the following:
a mode of transportation involved in transporting the second device;
an impact to the current travel situation;
an environment through which the second device is transported;
a status of the second device;
a status of a vehicle that is involved in transporting the second device; or
a presence of a travel companion.

5. The method of claim 4, wherein:
the contextual travel summary comprises at least the information about the mode of transportation and the impact to the current travel situation; and
the impact to the current travel situation comprises information related to a delay corresponding to the mode of transportation.

6. The method of claim 4, wherein:
the contextual travel summary comprises at least the information about the environment; and
the information about the environment comprises information about at least one of the following:
a landmark that is near a current location of the second device;
cellular coverage availability relating to the current location of the second device; or
street safety conditions relating to the current location of the second device.

7. The method of claim 1, further comprising:
receiving a message via a communication application, the message inquiring about the current travel situation associated with the second device, wherein:
the first device and the second device represent a same device; and
the presenting of the contextual travel summary comprises providing, via the communication application, the contextual travel summary as a suggested response to the received message.

8. The method of claim 7, further comprising:
enabling the suggested response to be edited by the user prior to transmitting the suggested response via the communication application; and
prompting the user to approve the suggested response prior to transmitting the suggested response via the communication application.

9. The method of claim 7, wherein the generating of the contextual travel summary further comprises generating the contextual travel summary by prompting a large-language model to generate a response to the received message based on the travel information provided to the large-language model.

10. The method of claim 1, wherein the first device and the second device represent different devices.

11. The method of claim 10, wherein the second device comprises a travel device that is attached to, integrated within, or placed within an object.

12. The method of claim 10, wherein the second device comprises a travel device that is carried by another person, the other person being someone other than the user.

13. The method of claim 12, wherein the presenting of the contextual travel summary to the user comprises presenting, via the first device, one or more status symbols next to an identifier of the other person.

14. The method of claim 1, wherein the contextual travel summary further comprises a selectable link to a digital map indicating a current location of the second device.

15. A computer-readable storage medium comprising instructions that, responsive to execution by a processor of a first device, cause the processor to:
receive travel information about a second device that is being transported;
generate a contextual travel summary by summarizing the travel information in a natural language, the contextual travel summary describing a current travel situation associated with the second device; and
present the contextual travel summary to a user of the first device.

16. The computer-readable storage medium of claim 15, wherein the instructions cause the processor to:
receive, after the contextual travel summary is presented, additional travel information about the second device that is being transported, the travel information representing first travel information and the additional travel information representing second travel information;
determine, based on a comparison of the second travel information to the first travel information, that there has been a change in the current travel situation associated with the second device;
generate, based on the determination, a second contextual travel summary by summarizing the additional travel information; and
present the second contextual travel summary to the user of the first device.

17. The computer-readable storage medium of claim 16, wherein the instructions cause the processor to:
receive, after the second contextual travel summary is presented, third travel information about the second device that is being transported;
determine, based on a comparison of the third travel information to the second travel information, that there has not been a change in the current travel situation associated with the second device; and
prevent, based on the determination that there has not been a change in the current travel situation, a generation of a third contextual travel summary based on the third travel information.

18. An apparatus comprising:
a computer processor configured to:
receive travel information about a transportation of the apparatus;
generate a contextual travel summary by summarizing the travel information in a natural language, the contextual travel summary describing a current travel situation associated with the apparatus; and
present the contextual travel summary to a user of the apparatus.

19. The apparatus of claim 18, further comprising:
a network interface configured to receive a message inquiring about the current travel situation of the user of the apparatus,
wherein the computer processor is further configured to provide the contextual travel summary as a suggested response to the received message.

20. The apparatus of claim 19, wherein:
the network interface is configured to transmit a version of the suggested response as a response to the received message; and
the computer processor is further configured to:
enable the suggested response to be edited by the user prior to transmission of the response; and
prompt the user to approve the suggested response prior to the transmission of the response.
